(19) United States
(12) Patent Application Publication
(10) Pub. No.: US 2026/0335983 A1
(43) Pub. Date: Oct. 29, 2026

(54) METHOD FOR MONITORING A FABRICATION PROCESS, ADDITIVE MANUFACTURING APPARATUS AND ADDITIVE MANUFACTURING METHOD

(71) Applicant: MITSUBISHI HEAVY INDUSTRIES, LTD., Tokyo (JP)

(72) Inventor: Ryuichi NARITA, Tokyo (JP)

(73) Assignee: MITSUBISHI HEAVY INDUSTRIES, LTD., Tokyo (JP)

(21) Appl. No.: 19/123,267

(22) PCT Filed: Nov. 6, 2023
(86) PCT No.: PCT/JP2023/039846

§ 371 Date: Apr. 22, 2025

(30) Foreign Application Priority Data
Nov. 8, 2022 (JP) 2022-178799

(51) Int. Cl. B22F 12/90; B22F 10/28; B22F 10/36; B33Y 10/00; B33Y 30/00; B33Y 50/02; G01N 21/88

(52) U.S. Cl. CPC B22F 12/90; B22F 10/28; B22F 10/36; B33Y 10/00; B33Y 30/00; B33Y 50/02; G01N 21/8806; G01N 21/8851; G01N 2021/8829

(57) ABSTRACT

A method for monitoring a fabrication process according to at least one embodiment of the present disclosure includes a step of forming a part of a fabrication product by irradiating an energy beam onto a layer of raw material powder to fuse and solidify the raw material powder of the layer, a first detection step of detecting presence or absence of a defect in the fabrication product during performance of the forming step, and a second detection step of measuring a surface shape of the fabrication product and detecting presence or absence of a defect in the fabrication product on the basis of the surface shape of the fabrication product after performing the forming step. The first detection step and the second detection step are performed each time the forming step is performed.

### TECHNICAL FIELD

The present disclosure relates to a method for monitoring a fabrication process, an additive manufacturing apparatus and an additive manufacturing method.

This application claims priority based on Japanese Patent Application No. 2022-178799 filed with the Japan Patent Office on Nov. 8, 2022, the contents of which are incorporated herein by reference.

### BACKGROUND

Among additive manufacturing methods for additively manufacturing three-dimensional objects, for example, in an additive manufacturing method using a powder bed method, a three-dimensional object (fabrication product) is formed by repeating fusion and solidification by irradiating an energy beam such as a light beam or an electron beam on metal powder which is raw material powder laid in layers (see Patent Document 1).

### Citation List

### Patent Literature

Patent Document 1: JP2017-20422A

### SUMMARY

### Technical Problem

In a region where an energy beam is irradiated, metal powder rapidly melts. Therefore, there is a possibility that defects may occur in the fabrication product, such as a cavity occurring inside the fabrication product.

Therefore, in order to ensure the quality of the fabrication product, it is necessary to perform non-destructive testing of the fabrication product after the fabrication of the fabrication product is completed.

However, non-destructive testing performed after the fabrication of the fabrication product is completed takes time and costs.

At least one embodiment of the present disclosure aims to reduce the inspection time and the cost required for inspection of an additively manufactured product in view of the above circumstances.

### Solution to Problem

(1) A method for monitoring a fabrication process according to at least one embodiment of the present disclosure comprises:
a step of forming a part of a fabrication product by irradiating an energy beam onto a layer of raw material powder to fuse and solidify the raw material powder of the layer;
a first detection step of detecting presence or absence of a defect in the fabrication product during performance of the forming step; and
a second detection step of measuring a surface shape of the fabrication product and detecting presence or absence of a defect in the fabrication product on the basis of the surface shape of the fabrication product after performing the forming step,
wherein the first detection step and the second detection step are performed each time the forming step is performed.
(2) An additive manufacturing apparatus according to at least one embodiment of the present disclosure comprises:
a powder bed formation part having a base plate on which a layer of supplied raw material powder is formed;
an energy beam irradiation part capable of irradiating an energy beam onto the layer; a first detection device configured to detect presence or absence of a defect in the fabrication product during irradiation of the energy beam; and
a second detection device configured to measure a surface shape of the fabrication product after irradiating the energy beam and detect presence or absence of a defect in the fabrication product on the basis of the surface shape of the fabrication product,
wherein the powder bed formation part is configured to form a layer of the raw material powder by supplying the raw material powder after the first detection device detects presence or absence of a defect in the fabrication product and the second detection device detects presence or absence of a defect in the fabrication product.
(3) An additive manufacturing method according to at least one embodiment of the present disclosure comprises:
a step of detecting presence or absence of a defect in the fabrication product by the method for monitoring a fabrication process according to (1) above.

### Advantageous Effects

According to at least one embodiment of the present disclosure, the inspection time and the cost required for inspection of an additively manufactured product may be reduced.

### BRIEF DESCRIPTION OF DRAWINGS

FIG. 1 is a schematic diagram showing the overall configuration of a three-dimensional additive manufacturing apparatus to which the method for monitoring a fabrication process according to at least one embodiment of the present disclosure can be applied.

FIG. 2 is a flowchart showing the procedure of processes in an additive manufacturing method according to a first embodiment using the three-dimensional additive manufacturing apparatus.

FIG. 3 is a figure showing emission intensity of light emitted from a test piece and standard deviation of the emission intensity when formed layers are sequentially formed on a test piece having a simulated defect.

FIG. 4 is a graph for explaining the relationship between the depth of a defect in the fabrication product and the output of a light beam when repairing the defect of the fabrication product.

FIG. 5A is a figure for explaining a scanning pattern of a light beam when repairing a defect of the fabrication product.

FIG. 5B is a figure for explaining a scanning pattern of a light beam when repairing a defect of the fabrication product.

FIG. 5C is a figure for explaining a scanning pattern of a light beam when repairing a defect of the fabrication product.

FIG. 5D is a figure for explaining a scanning pattern of a light beam when repairing a defect of the fabrication product.

FIG. 5E is a figure for explaining a scanning pattern of a light beam when repairing a defect of the fabrication product.

FIG. 5F is a figure for explaining a scanning pattern of a light beam when repairing a defect of the fabrication product.

FIG. 5G is a figure for explaining a scanning pattern of a light beam when repairing a defect of the fabrication product.

FIG. 6 is a flowchart showing the procedure of processes in an additive manufacturing method according to a second embodiment using the three-dimensional additive manufacturing apparatus.

FIG. 7 is a flowchart showing the procedure of processes in an additive manufacturing method according to a third embodiment using the three-dimensional additive manufacturing apparatus.

FIG. 8 is a flowchart showing the procedure of processes in an additive manufacturing method according to a fourth embodiment using the three-dimensional additive manufacturing apparatus.

FIG. 9 is a schematic diagram showing the overall configuration of a three-dimensional additive manufacturing apparatus which is an additive manufacturing apparatus to which the additive manufacturing method according to a sixth embodiment can be applied.

### DETAILED DESCRIPTION

Hereinafter, several embodiments of the present disclosure will be described with reference to the attached drawings. However, the dimensions, materials, shapes, and relative arrangement of the component parts described as embodiments or shown in the drawings are not intended to limit the scope of the present disclosure to these, but are merely illustrative examples.

For example, expressions indicating relative or absolute arrangement such as “in a certain direction”, “along a certain direction”, “parallel”, “perpendicular”, “center”, “concentric” or “coaxial” are intended to indicate not only strictly such arrangement but also states that are relatively displaced with tolerance, or with angles or distances to the extent that the same function can be obtained.

For example, expressions indicating that things are in an equal state, such as “identical”, “equal” and “homogeneous”, are intended to indicate not only a strictly equal state but also a state in which there exists a difference with tolerance, or to the extent that the same function can be obtained.

For example, expressions indicating shapes such as rectangular shape or cylindrical shape are intended to indicate not only strictly rectangular shape or cylindrical shape in a geometrically strict sense, but also shapes including concave parts, convex parts, or chamfered parts, etc., within a range where the same effect can be obtained.

On the other hand, expressions such as “comprising”, “provided with”, “including”, or “having” one component element are not exclusive expressions that exclude the presence of other component elements.

### Regarding Three-dimensional Additive Manufacturing Apparatus 1

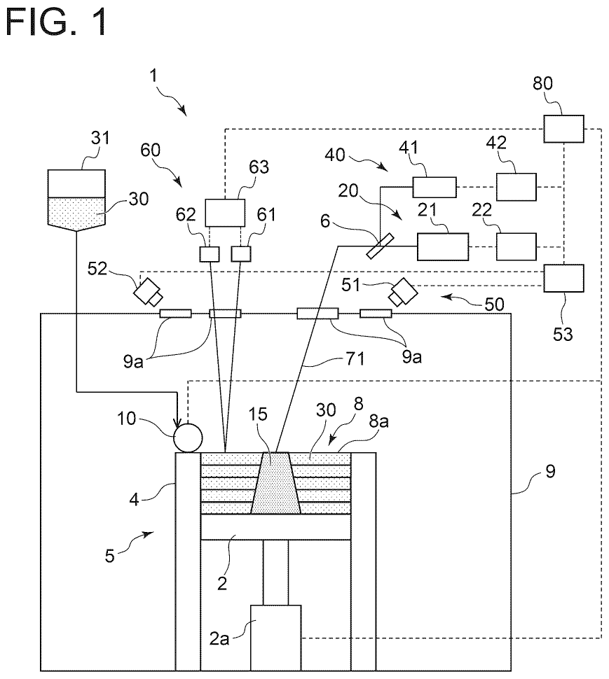

FIG. 1 is a schematic diagram showing the overall configuration of a three-dimensional additive manufacturing apparatus 1, which is an additive manufacturing apparatus to which the method for monitoring a fabrication process according to at least one embodiment of the present disclosure may be applied.

The three-dimensional additive manufacturing apparatus (additive manufacturing apparatus) 1 is a device for manufacturing a three-dimensional fabrication product 15 by performing additive manufacturing by irradiating a light beam 71 as an energy beam onto metal powder which is raw material powder laid in layers, and can perform additive manufacturing by a powder bed method.

The three-dimensional additive manufacturing apparatus 1 shown in FIG. 1 may form, for example, moving blades or stationary blades of turbines such as gas turbines or steam turbines, or components such as inner tubes, tail tubes or nozzles of combustors.

The three-dimensional additive manufacturing apparatus 1 shown in FIG. 1 includes a storage part 31 for raw material powder 30. The three-dimensional additive manufacturing apparatus 1 shown in FIG. 1 includes a powder bed formation part 5 having a base plate 2 on which a powder bed 8 is formed by sequentially stacking layers 8a of raw material powder 30 supplied from the storage part 31. The three-dimensional additive manufacturing apparatus 1 shown in FIG. 1 includes a light beam irradiation device 20 comprising a light beam irradiation part 21 capable of irradiating a light beam 71 onto the powder bed 8, and a light beam control part 22 for controlling the light beam irradiation part 21. The three-dimensional additive manufacturing apparatus 1 shown in FIG. 1 includes a powder layering part 10 to be described later, a drive cylinder 2a of the base plate 2, and a control part 80 for controlling the entire three-dimensional additive manufacturing apparatus 1. In addition, the three-dimensional additive manufacturing apparatus I shown in FIG. 1 includes a first detection device 40, a second detection device 50, and a flaw detection device 60.

The base plate 2 serves as a foundation on which the fabrication product 15 is fabricated. The base plate 2 is disposed inside a cylinder 4 having an approximately cylindrical shape with a vertical center axis, and may be raised and lowered by the drive cylinder 2a. The powder bed 8 formed on the base plate 2 has a new layer 8a formed by laying raw material powder 30 on the upper layer each time the base plate 2 descends in each cycle during the fabrication work.

The three-dimensional additive manufacturing apparatus 1 shown in FIG. 1 includes a powder layering part 10 for laying raw material powder 30 on the base plate 2 to form a layer 8a of raw material powder 30. The powder layering part 10 supplies raw material powder 30 from the storage part 31 to the upper surface side of the base plate 2, and flattens its surface to form a layer 8a having a substantially uniform thickness across the entire upper surface of the base plate 2. Each layer 8a formed in each cycle is sequentially stacked to form the powder bed 8, which is selectively fused and solidified by irradiation of a light beam 71 from the light beam irradiation part 21, and in the next cycle, raw material powder 30 is again laid on the upper layer side by the powder layering part 10, thereby forming a new layer 8a, which is stacked in layers.

Additionally, the raw material powder 30 supplied from the powder layering part 10 is a powdery substance that becomes the raw material of the fabrication product 15, and may widely adopt metal materials such as iron, copper, aluminum or titanium, or non-metal materials such as ceramics.

In the three-dimensional additive manufacturing apparatus 1 shown in FIG. 1, the powder bed formation part 5 and the powder layering part 10 are housed in a chamber 9. The chamber 9 is provided with window parts 9a at multiple locations through which the light beam 71 and light flux to be input and output to the second detection device 50 to be described later, and light flux to be input and output to the flaw detection device 60 can pass. Protective glass or the like is disposed at the window parts 9a so that the light beam 71 and light flux can pass through while maintaining airtightness between the inside and outside of the chamber 9.

The control part 80 is a control unit of the three-dimensional additive manufacturing apparatus 1 shown in FIG. 1, and is configured by an electronic computing device such as a computer. Information regarding the scanning position of the light beam 71 for each layer 8a is input to the control part 80 as information necessary for fabricating the fabrication product 15. The information regarding the irradiation position of the light beam 71 for each layer 8a may be input from an external device and stored in an unillustrated storage part of the control part 80, for example.

The control part 80 is configured to control the driving of the drive cylinder 2a of the powder bed formation part 5. Also, the control part 80 is configured to cooperatively control the first detection device 40, the second detection device 50, and the flaw detection device 60.

### Light Beam Irradiation Device 20

The light beam irradiation device 20 is an apparatus for irradiating a light beam 71 onto the powder bed 8, and has a light beam irradiation part 21 capable of irradiating a light beam 71 and a light beam control part 22 for controlling the light beam irradiation part 21, as described above.

The light beam control part 22 is configured by an electronic computing device such as a computer, and is configured to control the irradiation position of the light beam 71 irradiated by the light beam irradiation part 21 based on information regarding the irradiation position of the light beam 71 for each layer 8a received from the control part 80.

### First Detection Device 40

The first detection device 40 is a device for detecting presence or absence of a defect in the fabrication product 15 on the basis of emission intensity of light emitted from the fabrication product 15 when irradiating the light beam 71, that is, light emitted from a melt pool and plume formed when irradiating the light beam 71, and is, for example, a plasma emission monitor capable of detecting plasma emission in real time during the process. The first detection device 40 has a light detection part 41 for detecting light emitted from the fabrication product 15, and an emission monitor control part 42 capable of detecting presence or absence of a defect in the fabrication product 15 on the basis of the emission intensity of light detected by the light detection part 41.

The emission monitor control part 42 is configured by an electronic computing device such as a computer.

In the three-dimensional additive manufacturing apparatus 1 shown in FIG. 1, light emitted from the fabrication product 15 when irradiating the light beam 71 is reflected by a beam splitter 6 and enters the light detection part 41.

### Second Detection Device 50

The second detection device 50 is a shape measuring device capable of measuring the shape of the fabrication area, that is, the upper surface of the fabrication product 15 on the base plate 2 or the surface of the powder bed 8. In some embodiments, the second detection device 50 is, for example, an optical scanner based on a fringe projection method.

The second detection device 50 includes a projection part 51 which is a projector configured to project a fringe pattern (striped pattern) onto the fabrication area on the base plate 2, an imaging part 52 configured to capture the fringe pattern projected onto the fabrication area, and a concavity/convexity detection part 53 configured to be capable of detecting concavities and convexities in the fabrication area based on image data obtained by the imaging part 52.

The concavity/convexity detection part 53 is configured by an electronic computing device such as a computer, and is configured to be capable of detecting presence or absence of defects in a layer 8a of raw material powder 30 and presence or absence of defects in the fabrication product 15 based on the state of concavities and convexities in the fabrication area.

Additionally, the defects in the layer 8a detected by the second detection device 50 are undesired concavities and convexities in the layer 8a, etc. Also, the defects in the fabrication product 15 detected by the second detection device 50 are undesired deformations of the upper surface of the fabrication product 15 or opening defects, etc.

### Flaw Detection Device 60

The flaw detection device 60 is a flaw detection device for detecting defects in the fabrication product 15, and in some embodiments, is a flaw detection device using a laser ultrasonic method, for example.

The flaw detection device 60 includes a laser irradiation device 61 configured to be capable of irradiating pulse laser light for generating ultrasonic waves in the fabrication product 15, a laser interferometer 62 configured to irradiate laser light onto the fabrication product 15 and receive reflected light to measure vibration, that is, displacement of the surface of the fabrication product 15, and a flaw detection control part 63.

The flaw detection control part 63 is configured by an electronic computing device such as a computer, and is configured to be capable of detecting presence or absence of defects inside the fabrication product 15, and the position and size of defects, based on vibration of the surface of the fabrication product 15 detected by the laser interferometer 62.

### Issues in Conventional Additive Manufacturing Process

In a region where an energy beam is irradiated, raw material powder 30 rapidly melts. Therefore, there is a possibility that defects may occur in the fabrication product 15, such as a cavity occurring inside the fabrication product 15.

Therefore, in order to ensure the quality of the fabrication product 15, it is necessary to perform non-destructive testing of the fabrication product 15 after the fabrication of the fabrication product 15 is completed.

However, non-destructive testing performed after the fabrication of the fabrication product 15 is completed does not always detect all defects. Also, non-destructive testing takes time and costs.

Therefore, in the three-dimensional additive manufacturing apparatus 1 according to some embodiments, presence or absence of defects in the fabrication product 15 or the powder bed 8 is detected for each layer 8a of raw material powder 30 and the detected defects are also repaired as follows.

### Regarding Additive Manufacturing Method According to the First Embodiment Using the Three-Dimensional Additive Manufacturing Apparatus 1

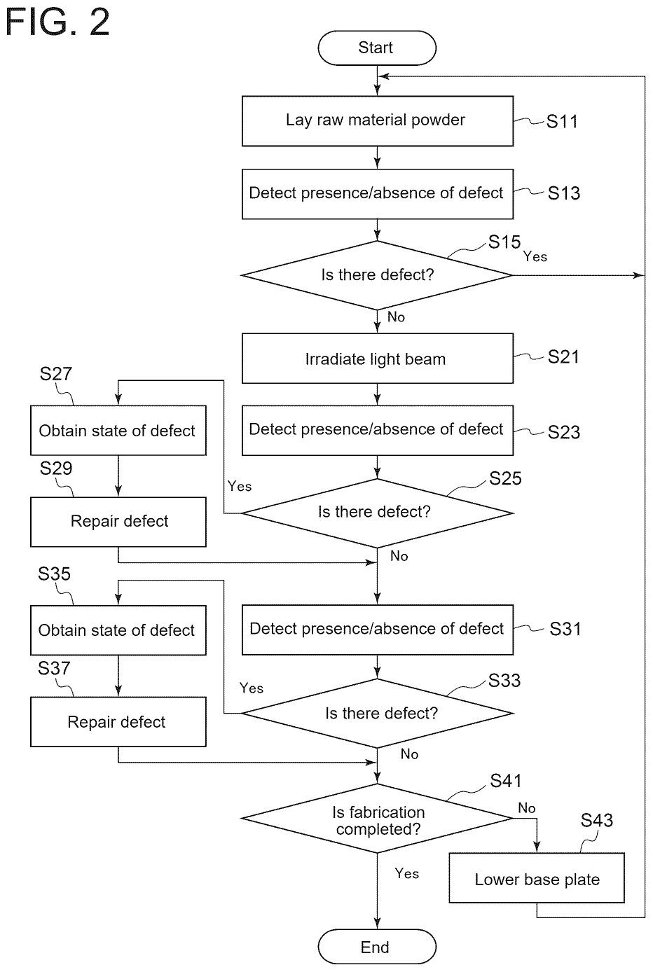

FIG. 2 is a flowchart showing the procedure of processes in an additive manufacturing method according to the first embodiment using the three-dimensional additive manufacturing apparatus 1 described above. The following explanation follows the flowchart of FIG. 2.

Additionally, in the additive manufacturing method according to the first embodiment, the fabrication process is monitored as follows.

In step S11, the control part 80, more specifically, the computing device of the control part 80, controls the powder layering part 10 to lay raw material powder 30. As a result, a layer 8a of raw material powder 30 supplied from the storage part 31 is formed.

Next, in step S13, the control part 80 controls the second detection device 50 to detect presence or absence of defects in the layer 8a of raw material powder 30 based on the state of concavities and convexities in the fabrication area. As a result, the second detection device 50 projects a fringe pattern (striped pattern) onto the fabrication area on the base plate 2, and detects concavities and convexities in the fabrication area based on image data obtained by the imaging part 52. Then, the second detection device 50 (concavity/convexity detection part 53) detects presence or absence of defects in the layer 8a based on the detection result of concavities and convexities in the fabrication area, and outputs the result to the control part 80.

In step S15, the control part 80 determines whether there is a defect in the layer 8a based on information from the second detection device 50.

If it is determined that there is a defect in the layer 8a, the control part 80 returns to step S11 and controls the powder layering part 10 to lay raw material powder 30. As a result, raw material powder 30 is re-laid.

If it is determined that there is no defect in the layer 8a, the control part 80 proceeds to step S21 and controls the light beam irradiation device 20 to irradiate the light beam 71. As a result, the light beam irradiation device 20 irradiates the light beam 71 based on information regarding the irradiation position of the light beam 71 for each layer 8a received from the control part 80.

Also, the control part 80, simultaneously with the irradiation of the light beam 71 in step S21, controls the first detection device 40 to detect presence or absence of a defect in the fabrication product 15 in step S23. As a result, the first detection device 40 detects presence or absence of a defect in the fabrication product 15 based on emission intensity of light emitted from the fabrication product 15.

When irradiating an energy beam such as a light beam 71 onto a layer 8a of raw material powder 30, if the irradiation state of the energy beam changes due to some reason, for example, if the output of the energy beam decreases, the emission intensity of light emitted from the fabrication product 15 changes. Also, an undesired change in the irradiation state of the energy beam may cause insufficient fusion of the raw material powder 30, which may lead to defects.

According to the three-dimensional additive manufacturing apparatus 1 of the present embodiment, based on the change in emission intensity of light emitted from the fabrication product 15, it is possible to recognize that there is a possibility that a problem or the like has occurred in the three-dimensional additive manufacturing apparatus 1.

Additionally, when a change in emission intensity occurs due to a problem or the like in the three-dimensional additive manufacturing apparatus 1, for example, there is a possibility that a problem may occur in the layer 8a currently being fabricated by irradiating the light beam 71 due to insufficient fusion of the raw material powder 30.

Therefore, when a change in emission intensity occurs due to a problem or the like in the three-dimensional additive manufacturing apparatus 1, for example, there is a possibility that a problem or the like has occurred in the three-dimensional additive manufacturing apparatus 1, or there is a possibility that a problem has occurred in the layer 8a currently being fabricated by irradiating the light beam 71.

Additionally, a change in emission intensity due to a problem or the like in the three-dimensional additive manufacturing apparatus 1 is not a change in emission intensity due to a problem or the like in the fabrication product 15 below the layer 8a currently being fabricated by irradiating the light beam 71, as described later. Therefore, even if a change in emission intensity due to a problem or the like in the three-dimensional additive manufacturing apparatus 1 occurs, there may be cases where the repair of defects in step S29 or step S37 to be described later is not necessary.

Also, as a result of the inventors' diligent studies, it has been found that when irradiating an energy beam such as a light beam 71 onto a layer 8a of raw material powder 30, if there is a defect such as a cavity in the substrate, that is, in the formed layer below the layer 8a currently being irradiated with the energy beam, changes occur such as differences in thermal conductivity or changes in the size of the melt pool compared to cases where there is no defect, and the emission intensity of light emitted from the fabrication product 15 changes.

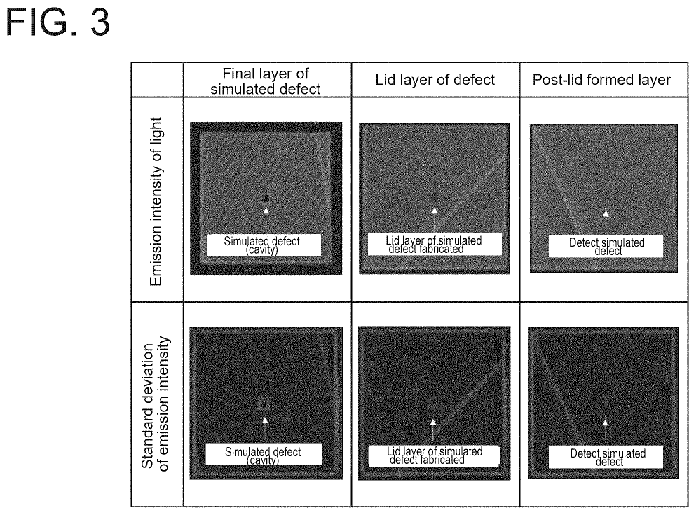

FIG. 3 is a figure showing emission intensity of light emitted from a test piece and standard deviation of the emission intensity when formed layers are sequentially formed on a test piece having a simulated defect.

The leftmost figure in FIG. 3 shows the emission intensity of light and the standard deviation of the emission intensity when a simulated defect of 0.5 mm square was created by not irradiating a light beam 71 in the 0.5 mm square area in the center of the figure. The formed layer created in this way is referred to as the final layer of the simulated defect.

The second figure from the left in FIG. 3 shows the emission intensity of light and the standard deviation of the emission intensity when irradiating a light beam 71 onto raw material powder 30 directly laid on the final layer of the simulated defect. The formed layer created in this way is referred to as the lid layer of the defect. If the final layer of the simulated defect mentioned above is the first layer, then the lid layer of the defect corresponds to the second layer.

During the fabrication of the lid layer of the defect, it can be seen from FIG. 3 that the emission intensity and the standard deviation of the emission intensity in the region directly above the simulated defect differ from the emission intensity and the standard deviation of the emission intensity in other regions, influenced by the simulated defect in the adjacent layer, that is, the final layer of the simulated defect, which is the layer below.

The rightmost figure in FIG. 3 shows the emission intensity of light and the standard deviation of the emission intensity when irradiating a light beam 71 onto raw material powder 30 directly laid on the lid layer of the defect. The formed layer created in this way is referred to as the post-lid formed layer. If the final layer of the simulated defect mentioned above is the first layer, then the post-lid formed layer corresponds to the third layer. During the fabrication of the post-lid formed layer, it can be seen from FIG. 3 that the emission intensity and the standard deviation of the emission intensity in the region directly above the simulated defect differ from the emission intensity and the standard deviation of the emission intensity in other regions, influenced by the simulated defect in the layer adjacent to the adjacent layer of the post-lid formed layer (lid layer of the defect), that is, the final layer of the simulated defect, which is two layers below.

According to the three-dimensional additive manufacturing apparatus 1 of the present embodiment, based on the change in emission intensity of light emitted from the fabrication product 15 when irradiating a light beam 71 onto a layer 8a of raw material powder 30, it is possible to detect presence or absence of a defect in a formed layer below the uppermost formed layer of the fabrication product 15, that is, a formed layer below the layer 8a currently being irradiated with the light beam 71. That is, according to the three-dimensional additive manufacturing apparatus 1 of the present embodiment, it is possible to recognize that, for example, there is a problem or the like in the fabrication product 15 below the layer 8a currently being fabricated by irradiating the light beam 71.

Therefore, according to the three-dimensional additive manufacturing apparatus 1 of the present embodiment, based on the emission intensity of light emitted from the fabrication product 15 by irradiation of the light beam 71, it is possible to detect whether there is a possibility that a problem or the like has occurred in the three-dimensional additive manufacturing apparatus 1, whether there is a possibility that a problem has occurred in the layer 8a currently being irradiated with the light beam 71, and presence or absence of defects such as cavities in the formed layer below the layer 8a.

In step S25, the control part 80 determines whether there is a defect in the fabrication product 15 based on information from the first detection device 40.

If it is determined that there is a defect in the fabrication product 15, the control part 80 proceeds to step S27 and controls the flaw detection device 60 to inspect the fabrication product 15 to obtain the state of the defect. As a result, the flaw detection device 60 inspects the fabrication product 15 as described above to detect the state of the defect, that is, presence or absence of defects inside the fabrication product 15, and the position and size of defects, and outputs the detection result to the control part 80.

Next, in step S29, the control part 80 controls the light beam irradiation device 20 to repair this defect based on the state of the defect obtained by the flaw detection device 60 in step S27. As a result, the light beam irradiation device 20 irradiates the light beam 71 onto the fabrication product 15 based on information regarding the position and size of the defect received from the control part 80. As a result, defects inside the fabrication product 15 are repaired.

Additionally, details of the repair of defects by the light beam irradiation device 20 will be described later.

If it is determined that there is no defect in the fabrication product 15 in step S25, or if step S29 described above is performed, the process proceeds to step S31, and the control part 80 controls the second detection device 50 to detect presence or absence of defects in the fabrication product 15 based on the state of concavities and convexities in the fabrication area. As a result, the second detection device 50 projects a fringe pattern (striped pattern) onto the fabrication area on the base plate 2, and detects concavities and convexities in the fabrication area based on image data obtained by the imaging part 52. Then, the second detection device 50 (concavity/convexity detection part 53) detects presence or absence of defects in the upper surface of the fabrication product 15 based on the detection result of concavities and convexities in the fabrication area, and outputs the result to the control part 80.

In step S33, the control part 80 determines whether there is a defect in the upper surface of the fabrication product 15 based on information from the second detection device 50.

If it is determined that there is a defect in the upper surface of the fabrication product 15, the control part 80 proceeds to step S35 and controls the flaw detection device 60 to inspect the fabrication product 15 to obtain the state of the defect. As a result, the flaw detection device 60 obtains the state of the defect by inspecting the fabrication product 15 as described above, and outputs the detection result to the control part 80.

Next, in step S37, the control part 80 controls the light beam irradiation device 20 to repair this defect based on the state of the defect obtained by the flaw detection device 60 in step S35. As a result, the light beam irradiation device 20 irradiates the light beam 71 onto the fabrication product 15 based on information regarding the position and size of the defect received from the control part 80. As a result, defects in the fabrication product 15 are repaired.

If it is determined that there is no defect in the fabrication product 15 in step S33, or if step S37 described above is performed, the process proceeds to step S41, and the control part 80 determines whether the fabrication of the fabrication product 15 has been completed.

If it is determined that the fabrication of the fabrication product 15 has not been completed, the process proceeds to step S43, and the control part 80 outputs a drive signal to the drive cylinder 2a to lower the base plate 2 by an amount corresponding to the thickness of one layer 8a. As a result, the base plate 2 is lowered by an amount corresponding to the thickness of one layer 8a.

When step S43 is executed, the process returns to step S11.

If it is determined that the fabrication of the fabrication product 15 has been completed in step S41, the control part 80 completes the fabrication of the fabrication product 15.

The method for monitoring a fabrication process performed when fabricating the fabrication product 15 using the three-dimensional additive manufacturing apparatus 1 of the present embodiment includes step S11, which is a step of forming a layer 8a of raw material powder 30 by supplying raw material powder 30. The method for monitoring a fabrication process according to the present embodiment includes step S21, which is a step of forming a part of the fabrication product 15 by irradiating a light beam 71 as an energy beam onto a layer 8a to fuse and solidify the raw material powder 30 of the layer 8a. The method for monitoring a fabrication process according to the present embodiment includes step S23, which is a first detection step of detecting presence or absence of a defect in the fabrication product 15 during performance of step S21. The method for monitoring a fabrication process according to the present embodiment includes step S31, which is a second detection step of measuring a surface shape of the fabrication product 15 and detecting presence or absence of a defect in the fabrication product 15 on the basis of the surface shape of the fabrication product 15 after performing step S21. In the method for monitoring a fabrication process according to the present embodiment, the first detection step which is step S23, and the second detection step which is step S31 are performed each time step S21 is performed.

According to the method for monitoring a fabrication process of the present embodiment, since the first detection step which is step S23, is performed during performance of step S21, the inspection time can be greatly reduced. Also, in the second detection step which is step S31, since presence or absence of a defect in the fabrication product 15 is detected on the basis of the surface shape of the fabrication product 15, inspection may be performed in a relatively short time. Therefore, according to the method for monitoring a fabrication process of the present embodiment, the inspection time of the fabrication product 15 may be reduced.

Also, according to the method for monitoring a fabrication process of the present embodiment, by performing the first detection step which is step S23, and the second detection step which is step S31 each time step S21 is performed, non-destructive testing after the fabrication of the fabrication product 15 is completed may be omitted, so the inspection time and the cost required for inspection of the fabrication product 15 may be reduced.

According to the method for monitoring a fabrication process of the present embodiment, by performing the first detection step which is step S23, and the second detection step which is step S31 each time step S21 is performed, the detection accuracy of defects in the fabrication product 15 may be improved compared to when the first detection step and the second detection step are performed individually, so the quality of the fabrication product 15 may be improved.

According to the additive manufacturing method using the method for monitoring a fabrication process of the present embodiment, a fabrication product 15 of good quality can be obtained while reducing the inspection time and the cost required for inspection of the fabrication product 15.

In the method for monitoring a fabrication process according to the present embodiment, in step S23, presence or absence of a defect in the fabrication product 15 is detected on the basis of emission intensity of light emitted from the fabrication product 15 when irradiating the light beam 71 in the forming step S21.

As a result, step S23 can be performed relatively easily with a relatively simple device configuration during performance of step S21, so the cost increase for the device to perform step S23 may be suppressed.

In the method for monitoring a fabrication process according to the present embodiment, in step S31, the surface shape of the fabrication product 15 is measured based on an image obtained by capturing a pattern projected onto the surface of the fabrication product 15.

As a result, step S31 can be performed relatively easily with a relatively simple device configuration, so the time required for performance of step S31 is relatively small, and the cost increase for the device to perform step S31 may be suppressed.

In the method for monitoring a fabrication process according to the present embodiment, when a defect is detected in step S23 or step S31, the fabrication product 15 is inspected to obtain the state of the defect (step S27, step S35).

As a result, more detailed state of the defect can be understood.

In the method for monitoring a fabrication process according to the present embodiment, in step S27 and step S35, the state of the defect is obtained by a laser ultrasonic method.

As a result, more detailed state of the defect can be understood non-destructively.

In the method for monitoring a fabrication process according to the present embodiment, after performing the step of forming the layer 8a, which is step S11, and before performing the forming step, which is step S21, the method includes step S13, which is a step of measuring the surface shape of the layer 8a and detecting presence or absence of a defect in the layer 8a on the basis of the surface shape of the layer 8a.

As a result, it is possible to understand the good or bad state of the layer 8a formed by laying the raw material powder 30.

In the method for monitoring a fabrication process according to the present embodiment, when a defect in the layer 8a is detected in step S13, the method includes a step (step S11) of newly forming a layer 8a of the raw material powder 30 by supplying the raw material powder 30.

As a result, the soundness of the layer 8a formed by laying the raw material powder 30 may be improved.

The three-dimensional additive manufacturing apparatus 1 according to the present embodiment includes a powder bed formation part 5 having a base plate 2 on which a layer 8a of supplied raw material powder 30 is formed. The three-dimensional additive manufacturing apparatus 1 according to the present embodiment includes a light beam irradiation device 20 as an energy beam irradiation part capable of irradiating a light beam 71 as an energy beam onto the layer 8a. The three-dimensional additive manufacturing apparatus 1 according to the present embodiment includes a first detection device 40 configured to detect presence or absence of a defect in the fabrication product 15 during irradiation of the light beam 71. The three-dimensional additive manufacturing apparatus 1 according to the present embodiment includes a second detection device 50 configured to measure a surface shape of the fabrication product 15 after irradiating the light beam 71 and detect presence or absence of a defect in the fabrication product 15 on the basis of the surface shape of the fabrication product 15. The powder bed formation part 5 is configured to form a layer 8a of the raw material powder 30 by supplying the raw material powder 30 after the first detection device 40 detects presence or absence of a defect in the fabrication product 15, and the second detection device 50 detects presence or absence of a defect in the fabrication product 15.

According to the three-dimensional additive manufacturing apparatus 1 of the present embodiment, since presence or absence of a defect in the fabrication product 15 is detected during irradiation of the light beam 71 for fabrication, the inspection time can be greatly reduced. Also, since presence or absence of a defect in the fabrication product 15 may be detected on the basis of the surface shape of the fabrication product 15 by the second detection device 50, inspection can be performed in a relatively short time. Therefore, according to the three-dimensional additive manufacturing apparatus 1 of the present embodiment, the inspection time of the fabrication product 15 may be reduced.

Also, according to the three-dimensional additive manufacturing apparatus 1 of the present embodiment, since presence or absence of defects may be detected by the first detection device 40 and the second detection device 50 every time each layer 8a is fabricated, non-destructive testing after the fabrication of the fabrication product 15 is completed may be omitted, and the inspection time and the cost required for inspection of the fabrication product 15 may be reduced.

### Regarding Repair of Defects by Light Beam Irradiation Device 20

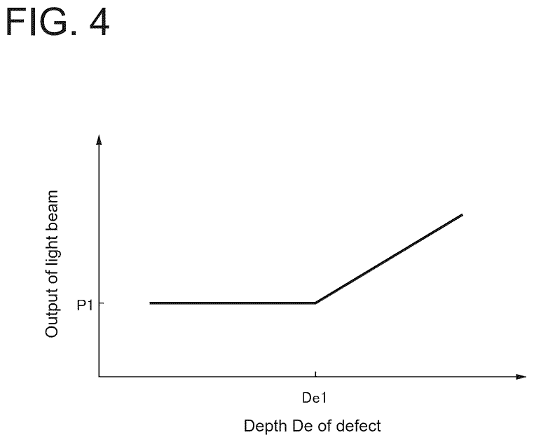

FIG. 4 is a graph for explaining the relationship between the depth De of a defect in the fabrication product 15 and the output of a light beam 71 when repairing the defect of the fabrication product 15.

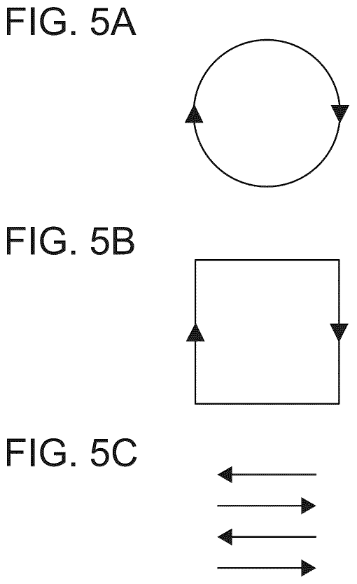

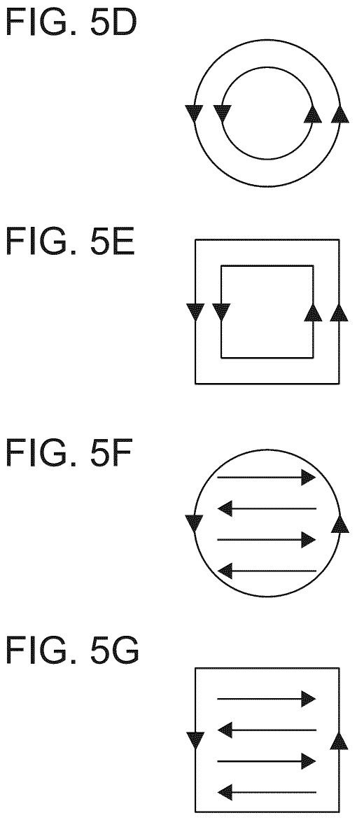

FIGS. 5A to 5G are figures for explaining scanning patterns of a light beam 71 when repairing a defect of the fabrication product 15.

### Regarding Output of Light Beam 71 During Defect Repair

In the three-dimensional additive manufacturing apparatus 1 according to the present embodiment, when repairing a defect of the fabrication product 15 in step S29 and step S37 described above, the defect is repaired by irradiating the light beam 71 under irradiation conditions set on the basis of the state of the defect obtained in step S27 or step S35.

Specifically, the control part 80 controls the light beam irradiation device 20 to repair the defect by irradiating the light beam 71 at a first output P1 when the depth De of the defect obtained in step S27 or step S35 is less than a specified depth De1. As a result, the light beam irradiation device 20 irradiates the light beam 71 at the first output P1 (see FIG. 4).

Here, the depth De of the defect is, for example, the distance from the surface of the fabrication product 15 to the bottom of a cavity or the like.

Also, the first output P1 is an output capable of at least re-melting the surface of the fabrication product 15. That is, since the surface of the fabrication product 15 cannot be re-melted unless the output of the irradiated light beam 71 exceeds a certain threshold value, if the depth De of the defect is less than the specified depth De1, the light beam 71 is output at the first output P1, which is equal to or greater than the above threshold value, regardless of the depth De of the defect.

The control part 80 controls the light beam irradiation device 20 to repair the defect by irradiating the light beam 71 at a second output P2 which is greater than the first output P1 and becomes larger as the depth De of the defect becomes deeper, when the depth De of the defect obtained in step S27 or step S35 is equal to or greater than the specified depth De1. As a result, the light beam irradiation device 20 irradiates the light beam 71 at the second output P2 (see FIG. 4).

In the three-dimensional additive manufacturing apparatus 1 according to the present embodiment, since defects of the fabrication product 15 are repaired in step S29 and step S37 described above, defects can be repaired during the fabrication of the fabrication product 15. As a result, non-destructive testing after the fabrication of the fabrication product 15 is completed may be omitted, and the inspection time and the cost required for inspection of the fabrication product 15 may be reduced.

By setting the output of the light beam 71 as described above during repair of defects of the fabrication product 15 in step S29 and step S37 described above, the defect can be repaired with an output of the light beam 71 according to the depth De of the defect, so the reliability of defect repair may be improved.

Also, when repairing defects of the fabrication product 15 in step S29 and step S37 described above, by irradiating the light beam 71 at the first output P1 even when the depth De of the defect is less than the specified depth De1, it is possible to suppress the occurrence of problems such as being unable to re-melt the surface of the fabrication product 15 during defect repair.

### Regarding Scanning of Light Beam 71 During Defect Repair

In the three-dimensional additive manufacturing apparatus 1 according to the present embodiment, when repairing a defect of the fabrication product 15 in step S29 and step S37 described above, whether to scan the light beam 71 or not is determined based on the maximum dimension dmax of the defect when viewed from above the fabrication product 15. In the three-dimensional additive manufacturing apparatus 1 according to the present embodiment, if the maximum dimension dmax of the defect is less than twice the beam width db of the light beam 71 (dmax<2×db), the defect is repaired by irradiating the light beam 71 without scanning.

In the three-dimensional additive manufacturing apparatus 1 according to the present embodiment, if the maximum dimension dmax of the defect is equal to or greater than twice the beam width db of the light beam 71 (dmax≥2×db), the defect is repaired by irradiating the light beam 71 while scanning.

As a result, the light beam 71 can be irradiated under appropriate irradiation conditions according to the size of the defect.

When repairing a defect by irradiating the light beam 71 while scanning, the scanning may be performed in scanning patterns shown in FIGS. 5A to 5G, for example. Additionally, in FIGS. 5A to 5G, the scanning patterns of the light beam 71 are represented by arrows.

For example, the scanning pattern shown in FIG. 5A is an example of scanning the light beam 71 along a circumferential direction.

For example, the scanning pattern shown in FIG. 5B is an example of scanning the light beam 71 along the sides of a rectangle.

For example, the scanning pattern shown in FIG. 5C is an example of scanning the light beam 71 in a linear reciprocating manner between one side and the other side within a region so as to fill the region.

For example, the scanning pattern shown in FIG. 5D is an example of scanning the light beam 71 along a circumferential direction so as to draw multiple concentric circles.

For example, the scanning pattern shown in FIG. 5E is an example of scanning the light beam 71 along the sides of a rectangle so as to draw multiple concentric rectangles.

For example, the scanning pattern shown in FIG. 5F is an example of performing scanning of the light beam 71 along a circumferential direction and scanning the light beam 71 in a linear reciprocating manner between one side and the other side within a circular region so as to fill the region.

For example, the scanning pattern shown in FIG. 5G is an example of performing scanning of the light beam 71 along the sides of a rectangle and scanning the light beam 71 in a linear reciprocating manner between one side and the other side within a rectangular region so as to fill the region.

Additionally, the scanning pattern when repairing a defect by irradiating the light beam 71 while scanning is not limited to the scanning patterns described above.

### Regarding Additive Manufacturing Method According to the Second Embodiment

Hereinafter, an additive manufacturing method according to the second embodiment will be described.

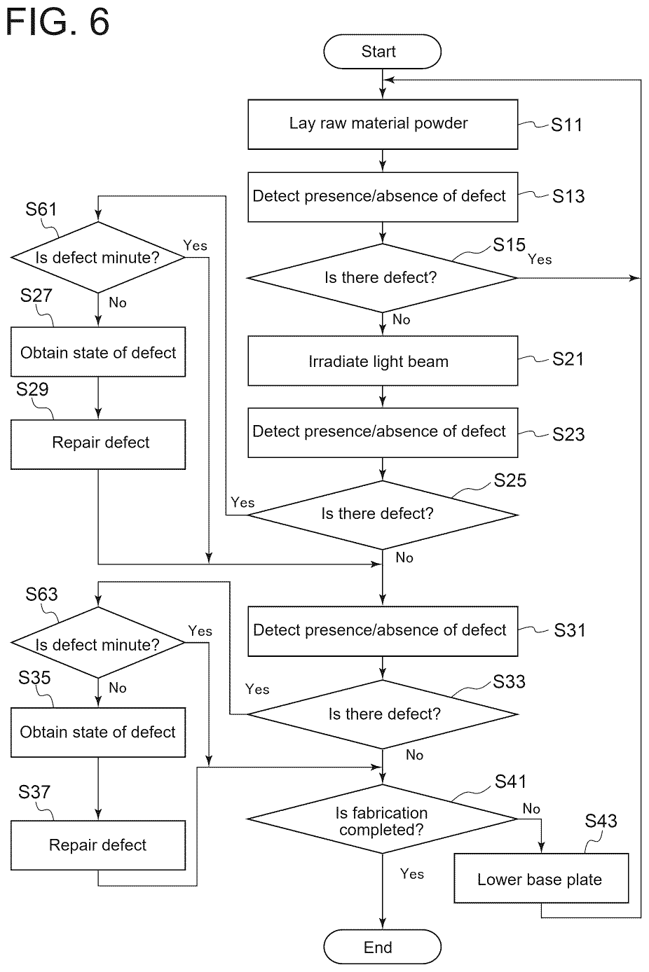

FIG. 6 is a flowchart showing the procedure of processes in an additive manufacturing method according to the second embodiment using the three-dimensional additive manufacturing apparatus 1 described above.

Additionally, in the following description, the same reference numerals are assigned to the same processes as in the additive manufacturing method according to the first embodiment, and detailed explanation may be omitted.

In the additive manufacturing method according to the second embodiment, even if it is determined that there is a defect in the fabrication product 15 based on information from the first detection device 40, or it is determined that there is a defect in the upper surface of the fabrication product 15 based on information from the second detection device 50, if the defect of the fabrication product 15 detected by the first detection device 40 or the second detection device 50 is determined to be minute, the process moves to the next process without performing the processes to repair the defect of the fabrication product 15.

The processes from step S11 to step S25 in FIG. 6 are the same as the processes from step S11 to step S25 in FIG. 2.

If step S25 is negatively determined, the control part 80 proceeds to step S31.

If step S25 is affirmatively determined, the process proceeds to step S61, and the control part 80 determines whether the defect of the fabrication product 15 detected in step S23 is minute or not.

In step S61, if it is determined that the defect of the fabrication product 15 detected in step S23 is minute, the control part 80 proceeds to step S31 without performing step S27 and step S29.

In step S61, if it is determined that the defect of the fabrication product 15 detected in step S23 is not minute, the control part 80 proceeds to step S27.

The processes from step S27 to step S33 in FIG. 6 are the same as the processes from step S27 to step S33 in FIG. 2.

If step S33 is negatively determined, the control part 80 proceeds to step S41.

If step S33 is affirmatively determined, the process proceeds to step S63, and the control part 80 determines whether the defect of the fabrication product 15 detected in step S31 is minute or not.

In step S63, if it is determined that the defect of the fabrication product 15 detected in step S31 is minute, the control part 80 proceeds to step S41 without performing step S35 and step S37.

In step S63, if it is determined that the defect of the fabrication product 15 detected in step S31 is not minute, the control part 80 proceeds to step S35.

The processes after step S35 in FIG. 6, and the processes after step S41 in FIG. 6 are the same as the processes after step S35 in FIG. 2, and the processes after step S41 in FIG. 2.

Additionally, when it is determined that the defect of the fabrication product 15 detected in step S23 is minute in step S61, or when it is determined that the defect of the upper surface of the fabrication product 15 detected in step S31 is minute in step S63, the three-dimensional additive manufacturing apparatus 1 may be configured to notify the operator of the three-dimensional additive manufacturing apparatus 1 that the defect of the fabrication product 15 was minute, or that the defect of the fabrication product 15 was minute.

### Regarding Additive Manufacturing Method According to the Third Embodiment

Hereinafter, an additive manufacturing method according to the third embodiment will be described.

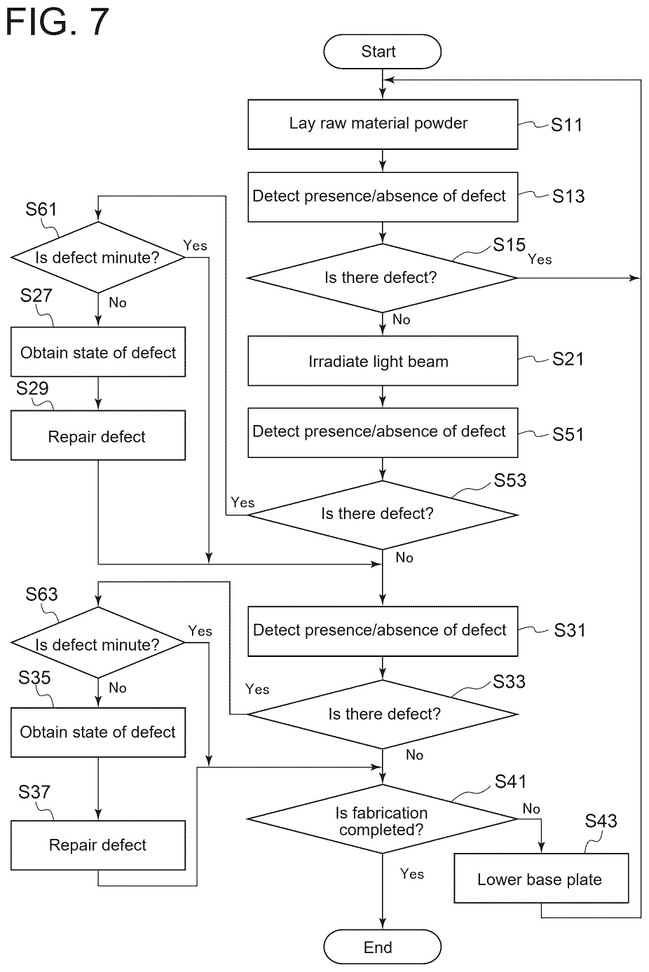

FIG. 7 is a flowchart showing the procedure of processes in an additive manufacturing method according to the third embodiment using the three-dimensional additive manufacturing apparatus 1 described above.

Additionally, in the following description, the same reference numerals are assigned to the same processes as in the additive manufacturing method according to the first embodiment and the additive manufacturing method according to the second embodiment, and detailed explanation may be omitted.

The processes from step S11 to step S21 in FIG. 7 are the same as the processes from step S11 to step S21 in FIG. 2.

In FIG. 7, when step S21 is performed, the process proceeds to step S51, and when step S51 is performed, the process proceeds to step S53.

Hereinafter, the content of step S11 and step S53 in the additive manufacturing method according to the third embodiment will be described.

In some embodiments of the additive manufacturing method, the emission intensity detected by the light detection part 41 is continuously acquired during scanning of the light beam 71, more specifically, for each minute scanning distance.

The inventors extracted the maximum value Smax, the average value Save, and the minimum value Smin of a plurality of emission intensity measurement values obtained during fabrication of one formed layer for each layer, and investigated their trends.

As a result of the inventors' diligent studies, it has been found that when there is no defect (cavity) inside the fabrication product 15, or even if there is a defect, it is a minute defect, the above-mentioned maximum value Smax, average value Save, and minimum value Smin are relatively stable in values in any formed layer.

As a result of the inventors' diligent studies, it has been found that when there is a defect inside the fabrication product 15 that cannot be said to be minute, the average value Save showed only a slight fluctuation during fabrication of the formed layer where the defect exists, and it is difficult to determine whether there is a defect inside the fabrication product 15 based on the change in the average value Save.

As a result of the inventors' diligent studies, it has been found that when there is a defect inside the fabrication product 15 that cannot be said to be minute, the minimum value Smin is relatively stable in values in any formed layer.

However, as a result of the inventors' diligent studies, it has been found that when there is a defect inside the fabrication product 15 that cannot be said to be minute, the maximum value Smax detected during fabrication of the layer where there is a defect (cavity) inside the fabrication product 15 is a relatively large value compared to the maximum value Smax when there is no defect (cavity) inside the fabrication product 15, or even if there is a defect, it is a minute defect.

Therefore, in the additive manufacturing method according to the third embodiment, when determining whether there is a defect in the fabrication product 15 based on information from the first detection device 40, attention is paid to the maximum value Smax of a plurality of emission intensity measurement values obtained during fabrication of one formed layer.

That is, in the additive manufacturing method according to the third embodiment, the average value of a predetermined number of measurement values in order from the measurement values with larger values from among a plurality of emission intensity measurement values obtained during fabrication of one formed layer is set as the representative value Rv of the emission intensity for that formed layer. Additionally, when the above-mentioned predetermined number is 1, the representative value Rv is the maximum value of a plurality of emission intensity values obtained during fabrication of one formed layer.

Or, from among a plurality of emission intensity measurement values obtained during fabrication of one formed layer, a specified proportion of measurement values in order from the measurement values with larger values out of the total number of measurement values obtained during fabrication of one formed layer are extracted, and their average value is set as the representative value Rv of the emission intensity for that formed layer.

Then, in the additive manufacturing method according to the third embodiment, presence or absence of a defect in the fabrication product 15 is detected based on this representative value Rv and a predetermined reference value Ref.

That is, the control part 80 obtains the above-mentioned representative value Rv from the detection result of emission intensity in the first detection device 40 in step S51. Then, as described later, the control part 80 determines presence or absence of a defect in the fabrication product 15 based on the above-mentioned representative value Rv and the predetermined reference value Ref.

Additionally, in step S51, the control part 80 may also perform the determination of presence or absence of a defect in the fabrication product 15 performed in step S23 of FIG. 2 according to the first embodiment described above.

Here, the above-mentioned reference value Ref is a value predetermined as a maximum value Smax that could be measured when there is no defect (cavity) inside the fabrication product 15, or even if there is a defect, it is a minute defect. This value may be, for example, the average value of maximum values Smax obtained by fabricating a plurality of fabrication products 15 under the same irradiation conditions as the irradiation conditions of the light beam 71 when fabricating the fabrication product 15, or may be the average value of maximum values Smax obtained when previously fabricating on a trial basis under the same irradiation conditions as the irradiation conditions of the light beam 71 when fabricating the fabrication product 15.

As described above, when there is a defect inside the fabrication product 15 that cannot be said to be minute, the maximum value Smax detected during fabrication of the layer where there is a defect (cavity) inside the fabrication product 15 is a relatively large value compared to the maximum value Smax when there is no defect (cavity) inside the fabrication product 15, or even if there is a defect, it is a minute defect. Therefore, the above-mentioned representative value Rv during fabrication of the layer where there is a defect (cavity) inside the fabrication product 15 is a relatively large value compared to the predetermined reference value Ref. That is, there is a correlation between the comparison result of the above-mentioned representative value Rv and the above-mentioned reference value Ref, and presence or absence of a defect in the fabrication product 15.

In the method for monitoring a fabrication process according to the additive manufacturing method of the third embodiment, in the first detection step (step S51), at least one measurement value taken in order from the largest emission intensity measurement value from among a plurality of measurement values of the emission intensity obtained by measuring the emission intensity multiple times during the performance of one forming step (step S21) is taken as a representative value Rv of the emission intensity during the performance of the one forming step, and presence or absence of a defect in the fabrication product 15 may be detected on the basis of the representative value Rv and a predetermined reference value Ref.

According to the additive manufacturing method of the third embodiment, since presence or absence of a defect in the fabrication product 15 may be detected based on the above-mentioned representative value Rv and the above-mentioned reference value Ref, the detection accuracy of presence or absence of a defect in the fabrication product 15 may be improved.

More specifically, in the additive manufacturing method according to the third embodiment, presence or absence of a defect in the fabrication product 15 is detected based on whether the above-mentioned representative value Rv becomes equal to or greater than a threshold value Th determined based on the above-mentioned reference value Ref.

Here, the above-mentioned threshold value Th is a value that is a specified proportion larger than the above-mentioned reference value Ref. For example, the threshold value Th may be 1.5 times the reference value Ref.

That is, the control part 80, in step S51, compares the above-mentioned representative value Rv with the above-mentioned threshold value Th, and determines that there is no defect in the fabrication product 15 when the above-mentioned representative value Rv is less than the above-mentioned threshold value Th.

The control part 80, in step S51, compares the above-mentioned representative value Rv with the above-mentioned threshold value Th, and determines that there is a defect in the fabrication product 15 when the above-mentioned representative value Rv is equal to or greater than the above-mentioned threshold value Th.

When step S11 is performed, the process proceeds to step S53, and if it is determined that there is no defect in the fabrication product 15 in step S51, the process proceeds to step S31, and if it is determined that there is a defect in the fabrication product 15, the process proceeds to step S61.

In the method for monitoring a fabrication process according to the additive manufacturing method of the third embodiment, in the first detection step (step S51), it may be determined that there is no defect in the fabrication product 15 when the representative value Rv is less than a threshold value Th determined based on the reference value Ref, and it may be determined that there is a defect in the fabrication product 15 when the representative value Rv is equal to or greater than the threshold value Th.

According to the additive manufacturing method of the third embodiment, since presence or absence of a defect in the fabrication product 15 may be detected by comparison of the above-mentioned representative value Rv with the above-mentioned threshold value Th, the detection accuracy of presence or absence of a defect in the fabrication product 15 may be improved.

As a result of the inventors' diligent studies, it has been found that when performing fabrication of one layer multiple times, if the frequency of occurrence of representative values Rv that are equal to or greater than the threshold value Th is low, there is a low possibility that a defect exists in the fabrication product 15, and if the frequency of occurrence of representative values Rv that are equal to or greater than the threshold value Th is high, there is a high possibility that a defect exists in the fabrication product 15.

Therefore, in the additive manufacturing method according to the third embodiment, when performing fabrication of one layer multiple times, it may be determined that there is no defect in the fabrication product 15 when the frequency of occurrence Fr of representative values Rv that are equal to or greater than the threshold value Th is less than a prescribed frequency of occurrence Fr1, and it may be determined that there is a defect in the fabrication product 15 when the frequency of occurrence Fr of representative values Rv that are equal to or greater than the threshold value Th is equal to or greater than the prescribed frequency of occurrence Fr1.

That is, the control part 80 may, in step S51, compare the frequency of occurrence Fr with the prescribed frequency of occurrence Fr1, and determine that there is no defect in the fabrication product 15 when the frequency of occurrence Fr is less than the prescribed frequency of occurrence Fr1.

The control part 80 may, in step S51, compare the frequency of occurrence Fr with the prescribed frequency of occurrence Fr1, and determine that there is a defect in the fabrication product 15 when the frequency of occurrence Fr is equal to or greater than the prescribed frequency of occurrence Fr1.

In the method for monitoring a fabrication process according to the additive manufacturing method of the third embodiment, in the first detection step (step S51), when the forming step (step S21) is performed multiple times, it may be determined that there is no defect in the fabrication product 15 when the frequency of occurrence Fr of representative values Rv that are equal to or greater than the threshold value Th is less than a prescribed frequency of occurrence Fr1, and it may be determined that there is a defect in the fabrication product 15 when the frequency of occurrence Fr of representative values Ry that are equal to or greater than the threshold value Th is equal to or greater than the prescribed frequency of occurrence Fr1.

As a result, since presence or absence of a defect in the fabrication product 15 may be detected by the frequency of occurrence Fr of representative values Rv that are equal to or greater than the threshold value Th, the detection accuracy of presence or absence of a defect in the fabrication product 15 may be improved.

The processes after step S61 in FIG. 7, and the processes after step S31 in FIG. 7 are the same as the processes after step S61 in FIG. 6, and the processes after step S31 in FIG. 6.

### Regarding Additive Manufacturing Method According to the Fourth Embodiment

Hereinafter, an additive manufacturing method according to the fourth embodiment will be described.

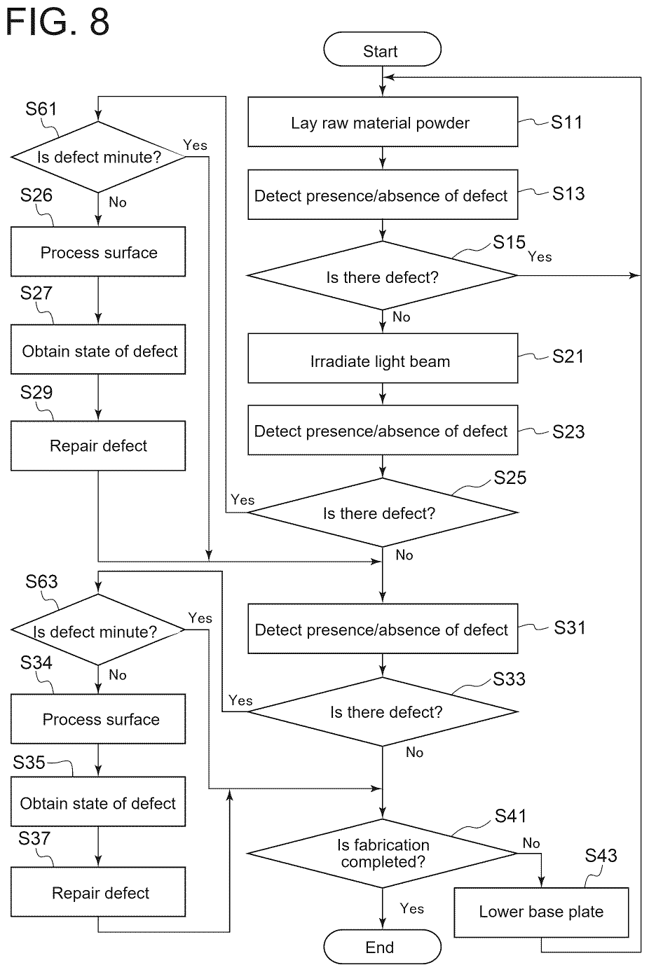

FIG. 8 is a flowchart showing the procedure of processes in an additive manufacturing method according to the fourth embodiment using the three-dimensional additive manufacturing apparatus 1 described above.

Additionally, in the following description, the same reference numerals are assigned to the same processes as in any of the additive manufacturing methods according to the above-mentioned embodiments, and detailed explanation may be omitted.

The processes from step S11 to step S25 in FIG. 8 are the same as the processes from step S11 to step S25 in FIG. 2.

If step S25 is negatively determined, the control part 80 proceeds to step S31.

If step S25 in FIG. 8 is affirmatively determined, the process proceeds to step S61, and the control part 80 determines whether the defect of the fabrication product 15 detected in step S23 is minute or not.

In step S61, if it is determined that the defect of the fabrication product 15 detected in step S23 is minute, the control part 80 proceeds to step S31 without performing step S26, step S27, and step S29.

In step S61, if it is determined that the defect of the fabrication product 15 detected in step S23 is not minute, the control part 80 proceeds to step S26.

Hereinafter, the content of step S26 in the additive manufacturing method according to the fourth embodiment will be described.

For example, when irradiating laser light onto the surface of the fabrication product 15 at an angle, that is, when irradiating laser light from an angle inclined relative to the normal direction of the surface of the fabrication product 15, if the surface roughness of the surface of the fabrication product 15 is relatively large, scattered light from the surface of the fabrication product 15 is affected by the surface roughness. Therefore, when obtaining the state of a defect by a laser ultrasonic method, such as the flaw detection device 60 described above, it becomes difficult to accurately obtain the state of the defect.

Also, generally, the surface roughness of the surface of the fabrication product 15 is relatively large. Therefore, there is a possibility that the detection accuracy of presence or absence of defects inside the fabrication product 15, and the position and size of defects by the flaw detection device 60 may decrease.

Therefore, in the additive manufacturing method according to the fourth embodiment, after step S25 is affirmatively determined and step S61 is negatively determined, before obtaining the state of the defect by examining the fabrication product 15 with the flaw detection device 60 in step S27, in step S26, the surface roughness of the surface of the fabrication product 15 is made smaller than before beam irradiation by processing the surface of the fabrication product 15 by irradiating a beam. That is, the additive manufacturing method according to the fourth embodiment includes step S26, which is a step of processing the surface of the fabrication product by irradiating a beam when a defect of the fabrication product 15 is detected based on information from the first detection device 40.

Additionally, in the additive manufacturing method according to the fourth embodiment, the beam irradiated onto the fabrication product 15 in step S26 is the light beam 71 irradiated by the light beam irradiation part 21 of the light beam irradiation device 20. The irradiation conditions, such as the output of the light beam 71 irradiated onto the fabrication product 15 in step S26, are set to irradiation conditions suitable for processing the surface of the fabrication product 15 to make the surface roughness of the fabrication product 15 relatively small.

If step S61 is negatively determined (if it is determined that the defect of the fabrication product 15 is not minute), the control part 80 proceeds to step S26 and controls the light beam irradiation device 20 to irradiate the light beam 71 onto the fabrication product 15 under irradiation conditions suitable for processing the surface of the fabrication product 15 to make the surface roughness of the fabrication product 15 relatively small. As a result, the light beam 71 is irradiated onto the surface of the fabrication product 15, and the surface roughness of the fabrication product 15 becomes relatively small.

When step S26 is performed, the process proceeds to step S27.

The processes from step S27 to step S33 in FIG. 8 are the same as the processes from step S27 to step S33 in FIG. 6.

In step S35 in FIG. 8, similar to step S27, the state of the defect is obtained by examining the fabrication product 15 with the flaw detection device 60.

Therefore, in the additive manufacturing method according to the fourth embodiment, after step S33 is affirmatively determined and step S63 is negatively determined, before obtaining the state of the defect by examining the fabrication product 15 with the flaw detection device 60 in step S35, in step S34, the surface roughness of the surface of the fabrication product 15 is made smaller than before beam irradiation by processing the surface of the fabrication product 15 by irradiating a beam. That is, the additive manufacturing method according to the fourth embodiment includes step S34, which is a step of processing the surface of the fabrication product by irradiating a beam when a defect of the fabrication product 15 (a defect in the upper surface of the fabrication product 15) is detected based on information from the second detection device 50.

Additionally, in the additive manufacturing method according to the fourth embodiment, the beam irradiated onto the fabrication product 15 in step S34 is the light beam 71 irradiated by the light beam irradiation part 21 of the light beam irradiation device 20. The irradiation conditions, such as the output of the light beam 71 irradiated onto the fabrication product 15 in step S34, are set to irradiation conditions suitable for processing the surface of the fabrication product 15 to make the surface roughness of the fabrication product 15 relatively small.

If step S33 is negatively determined, the control part 80 proceeds to step S41.

If step S33 is affirmatively determined, the process proceeds to step S63, and the control part 80 determines whether the defect of the upper surface of the fabrication product 15 detected in step S31 is minute or not.

In step S63, if it is determined that the defect of the upper surface of the fabrication product 15 detected in step S31 is minute, the control part 80 proceeds to step S41 without performing step S34, step S35, and step S37.

In step S63, if it is determined that the defect of the upper surface of the fabrication product 15 detected in step S31 is not minute, the control part 80 proceeds to step S34. In step S34, the control part 80 controls the light beam irradiation device 20 to irradiate the light beam 71 onto the fabrication product 15 under irradiation conditions suitable for processing the surface of the fabrication product 15 to make the surface roughness of the fabrication product 15 relatively small. As a result, the light beam 71 is irradiated onto the surface of the fabrication product 15, and the surface roughness of the fabrication product 15 becomes relatively small.

In the method for monitoring a fabrication process according to the additive manufacturing method of the fourth embodiment, when a defect is detected in the first detection step (step S23, step S51) or the second detection step (step S31), the method may include a step (step S26, step S34) of processing the surface of the fabrication product 15 by irradiating a beam, and a step (step S27, step S35) of inspecting the fabrication product 15 whose surface has been processed in the step (step S26, step S34) of processing the surface of the fabrication product 15 to obtain the state of the defect.

According to the additive manufacturing method of the fourth embodiment, even when performing an inspection that is easily affected by the surface roughness of the fabrication product 15, such as a flaw detection device 60 which conducts flaw detection by a laser ultrasonic method, the accuracy of the inspection results can be more easily ensured.

Also, according to the additive manufacturing method of the fourth embodiment, since the surface of the fabrication product 15 is processed by the light beam 71 irradiated by the light beam irradiation part 21 of the light beam irradiation device 20, no additional device is required, and the surface of the fabrication product 15 can be processed relatively easily.

When step S34 is performed, the process proceeds to step S35.

The content of the processes after step S35 in FIG. 8, and the processes after step S41 in FIG. 8 is the same as the content of the processes after step S35 in FIG. 6, and the processes after step S41 in FIG. 6.

Additionally, if step S26 has been performed prior to the performance of step S34, since defect repair has been performed in the subsequent step S29, beam irradiation by step S34 may be performed only on the repair location of step S29 and its surroundings.

### Regarding Additive Manufacturing Method According to the Fifth Embodiment

Hereinafter, an additive manufacturing method according to the fifth embodiment will be described.

The additive manufacturing method according to the fifth embodiment differs from the additive manufacturing method according to the fourth embodiment described above in the source of the beam irradiated onto the fabrication product 15 in step S26 and step S34, and is the same as the fourth embodiment described above in other respects.

In the additive manufacturing method according to the fourth embodiment described above, the beam irradiated onto the fabrication product 15 in step S26 and step S34 was the light beam 71 irradiated by the light beam irradiation part 21 of the light beam irradiation device 20.

In the additive manufacturing method according to the fifth embodiment, the beam irradiated onto the fabrication product 15 in step S26 and step S34 is laser light irradiated by the laser irradiation device 61 included in the flaw detection device 60.

Additionally, the irradiation conditions, such as the output of the laser light, of the laser light irradiated by the laser irradiation device 61 in step S26 and step S34 are set to irradiation conditions suitable for processing the surface of the fabrication product 15 to make the surface roughness of the fabrication product 15 relatively small.

According to the additive manufacturing method of the fifth embodiment, since the surface of the fabrication product 15 is processed by laser light irradiated by the laser irradiation device 61 included in the flaw detection device 60, no additional device is required, and the surface of the fabrication product 15 can be processed relatively easily.

### Regarding Additive Manufacturing Method According to the Sixth Embodiment

Hereinafter, an additive manufacturing method according to the sixth embodiment will be described.

The additive manufacturing method according to the sixth embodiment differs from the additive manufacturing methods according to the fourth embodiment and the fifth embodiment described above in the source of the beam irradiated onto the fabrication product 15 in step S26 and step S34, and is the same as the fourth embodiment and the fifth embodiment described above in other respects.

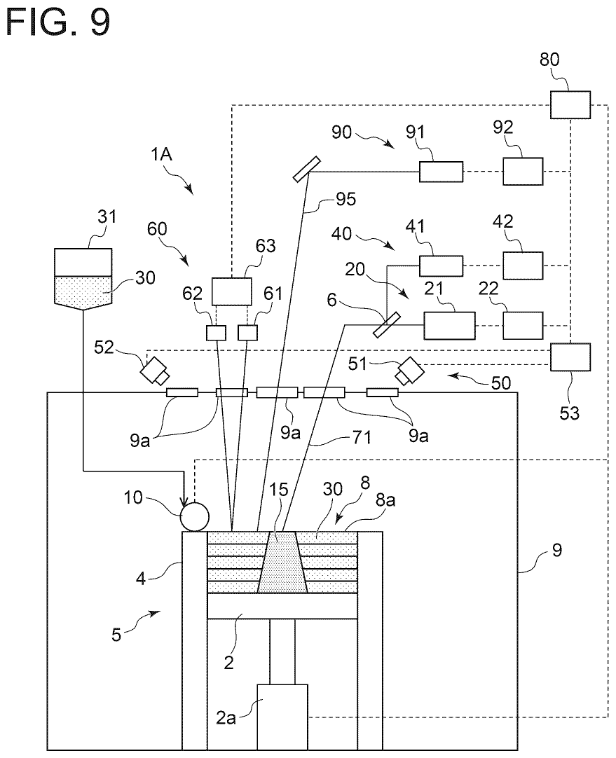

FIG. 9 is a schematic diagram showing the overall configuration of a three-dimensional additive manufacturing apparatus 1A, which is an additive manufacturing apparatus to which the additive manufacturing method according to the sixth embodiment can be applied.

The three-dimensional additive manufacturing apparatus IA shown in FIG. 9 has the same configuration as the three-dimensional additive manufacturing apparatus 1 shown in FIG. 1, except for the addition of a surface processing irradiation device 90.

The surface processing irradiation device 90 is a device for irradiating laser light 95 onto the surface of the fabrication product 15, and has a laser light irradiation part 91 capable of irradiating laser light 95, and a laser light control part 92 for controlling the laser light irradiation part 91.

The laser light control part 92 is configured by an electronic computing device such as a computer, and is configured to control the irradiation position of the laser light 95 irradiated by the laser light irradiation part 91 based on information received from the control part 80.

Additionally, the irradiation conditions, such as the output of the laser light, of the laser light 95 irradiated by the laser light irradiation part 91 in step S26 and step S34 are set to irradiation conditions suitable for processing the surface of the fabrication product 15 to make the surface roughness of the fabrication product 15 relatively small.

According to the additive manufacturing method of the sixth embodiment the setting work associated with changes in irradiation conditions for the light beam irradiation part 21 of the light beam irradiation device 20 or the laser irradiation device 61 of the flaw detection device 60 becomes unnecessary.

The present disclosure is not limited to the embodiments described above, but includes forms with modifications added to the above-mentioned embodiments, and forms appropriately combining these forms.

The contents described in the above embodiments are understood, for example, as follows.
(1) A method for monitoring a fabrication process according to at least one embodiment of the present disclosure comprises a step (step S21) of forming a part of a fabrication product 15 by irradiating an energy beam (light beam 71) onto a layer 8a of raw material powder 30 to fuse and solidify the raw material powder 30 of the layer 8a, a first detection step (step S23, step S51) of detecting presence or absence of a defect in the fabrication product 15 during performance of the forming step (step S21), and a second detection step (step S31) of measuring a surface shape of the fabrication product 15 and detecting presence or absence of a defect in the fabrication product 15 on the basis of the surface shape of the fabrication product 15 after performing the forming step (step S21). The first detection step (step S23, step S51) and the second detection step (step S31) are performed each time the forming step (step S21) is performed.

According to the method of (1) above, since the first detection step (step S23, step S51) is performed during performance of the forming step (step S21), the inspection time can be greatly reduced. Also, in the second detection step (step S31), since presence or absence of a defect in the fabrication product 15 is detected on the basis of the surface shape of the fabrication product 15, inspection can be performed in a relatively short time. Therefore, according to the method of (1) above, the inspection time of the fabrication product 15 may be reduced.

Also, according to the method of (1) above, by performing the first detection step (step S23, step S51) and the second detection step (step S31) each time the forming step (step S21) is performed, non-destructive testing after the fabrication of the fabrication product 15 is completed may be omitted, so the inspection time and the cost required for inspection of the fabrication product 15 may be reduced.
(2) In some embodiments, in the method of (1) above, in the first detection step (step S23, step S51), it would be good to detect presence or absence of a defect in the fabrication product 15 on the basis of emission intensity of light emitted from the fabrication product 15 when irradiating the energy beam (light beam 71) in the forming step (step S21).

According to the method of (2) above, the first detection step (step S23, step S51) can be performed relatively easily with a relatively simple device configuration during performance of the forming step (step S21), so the cost increase for the device to perform the first detection step (step S23, step S51) may be suppressed.
(3) In some embodiments, in the method of (2) above, in the first detection step (step S23), it would be good to detect presence or absence of a defect in a formed layer below the uppermost formed layer of the fabrication product 15 on the basis of the emission intensity.

According to the method of (3) above, it is possible to detect presence or absence of a defect in a formed layer below the uppermost formed layer of the fabrication product 15 based on the emission intensity of light emitted from the fabrication product 15 when irradiating an energy beam (light beam 71) onto a layer 8a of raw material powder 30.
(4) In some embodiments, in the method of (2) or (3) above, in the first detection step (step S23), it would be good to detect presence or absence of a defect in the uppermost formed layer of the fabrication product 15 on the basis of the emission intensity.

According to the method of (4) above, it is possible to detect the occurrence of defects in the fabrication product 15 attributable to, for example, an undesired change in the irradiation state of the energy beam (light beam 71).
(5) In some embodiments, in the method of (2) above, in the first detection step (step S51), at least one measurement value taken in order from the largest emission intensity measurement value from among a plurality of measurement values of the emission intensity obtained by measuring the emission intensity multiple times during the performance of one forming step (step S21) may be taken as a representative value Rv of the emission intensity during the performance of the one forming step, and presence or absence of a defect in the fabrication product 15 may be detected on the basis of the representative value Rv and a predetermined reference value Ref.

As a result of the inventors' diligent studies, it has been found that there is a correlation between the comparison result of the above-mentioned representative value Rv and the above-mentioned reference value Ref, and presence or absence of a defect in the fabrication product 15.

According to the method of (5) above, since presence or absence of a defect in the fabrication product 15 may be detected based on the above-mentioned representative value Rv and the above-mentioned reference value Ref, the detection accuracy of presence or absence of a defect in the fabrication product 15 may be improved.
(6) In some embodiments, in the method of (5) above, in the first detection step (step S51), it would be good to determine that there is no defect in the fabrication product 15 when the representative value Rv is less than a threshold value Th determined based on the reference value Ref, and to determine that there is a defect in the fabrication product 15 when the representative value Rv is equal to or greater than the threshold value Th.

According to the method of (6) above, since presence or absence of a defect in the fabrication product 15 may be detected by comparison of the above-mentioned representative value Rv with the above-mentioned threshold value Th, the detection accuracy of presence or absence of a defect in the fabrication product 15 may be improved.
(7) In some embodiments, in the method of (6) above, in the first detection step (step S51), when the forming step (step S21) is performed multiple times, it may be determined that there is no defect in the fabrication product 15 when the frequency of occurrence Fr of representative values Rv that are equal to or greater than the threshold value Th is less than a prescribed frequency of occurrence Fr1, and it may be determined that there is a defect in the fabrication product 15 when the frequency of occurrence Fr of representative values Ry that are equal to or greater than the threshold value Th is equal to or greater than the prescribed frequency of occurrence Fr1.

According to the method of (7) above, since presence or absence of a defect in the fabrication product 15 may be detected by the frequency of occurrence Fr of representative values Rv that are equal to or greater than the threshold value Th, the detection accuracy of presence or absence of a defect in the fabrication product 15 may be improved.
(8) In some embodiments, in any one of the methods of (1) to (7) above, in the second detection step (step S31), it would be good to measure the surface shape of the fabrication product 15 based on an image obtained by capturing a pattern projected onto the surface of the fabrication product 15.

According to the method of (8) above, the second detection step (step S31) can be performed relatively easily with a relatively simple device configuration, so the time required for performance of the second detection step (step S31) is relatively small, and the cost increase for the device to perform the second detection step (step S31) may be suppressed.
(9) In some embodiments, in any one of the methods of (1) to (8) above, it would be good to include a step (step S27, step S35) of inspecting the fabrication product 15 to obtain the state of the defect when a defect is detected in the first detection step (step S23, step S51) or the second detection step (step S31).

According to the method of (9) above, more detailed state of the defect can be understood.
(10) In some embodiments, in any one of the methods of (1) to (8) above, when a defect is detected in the first detection step (step S23, step S51) or the second detection step (step S31), it may include a step (step S26, step S34) of processing the surface of the fabrication product 15 by irradiating a beam, and a step (step S27, step S35) of inspecting the fabrication product 15 whose surface has been processed in the step (step S26, step S34) of processing the surface of the fabrication product 15 to obtain the state of the defect.

According to the method of (10) above, by processing the surface of the fabrication product 15 by irradiating a beam to make the surface roughness 15 of the surface of the fabrication product 15 smaller, even when performing an inspection that is easily affected by the surface roughness of the surface of the fabrication product 15, for example, the accuracy of the inspection results can be more easily ensured.
(11) In some embodiments, in the method of (9) or (10) above, in the step of obtaining (step S27, step S35), it would be good to obtain the state of the defect by a laser ultrasonic method.

According to the method of (11) above, more detailed state of the defect can be understood non-destructively.
(12) In some embodiments, in the method of (11) above, it would be good to include a step (step S29, step S37) of repairing the defect by irradiating the energy beam (light beam 71) under irradiation conditions set on the basis of the state of the defect obtained in the step of obtaining (step S27, step S35).

According to the method of (12) above, since defects can be repaired during the fabrication of the fabrication product 15, non-destructive testing after the fabrication of the fabrication product 15 is completed may be omitted, and the inspection time and the cost required for inspection of the fabrication product 15 may be reduced.
(13) In some embodiments, in the method of (12) above, in the step of repairing (step S29, step S37), it would be good to repair the defect by irradiating the energy beam (light beam 71) at a first output P1 when the depth De of the defect obtained in the step of obtaining (step S27, step S35) is less than a specified depth De1. In the step of repairing (step S29, step S37), it would be good to repair the defect by irradiating the energy beam (light beam 71) at a second output P2 which is greater than the first output P1 and becomes larger as the depth De of the defect becomes deeper, when the depth De of the defect obtained in the step of obtaining (step S27, step S35) is equal to or greater than the specified depth De1.

According to the method of (13) above, the defect can be repaired with an output of the energy beam (light beam 71) according to the depth of the defect, so the reliability of defect repair may be improved.

Additionally, even if the depth De of the defect is relatively shallow, the output of the energy beam (light beam 71) to be irradiated must be at or above a certain output to re-melt the surface of the fabrication product 15. According to the method of (13) above, by irradiating the energy beam (light beam 71) at the first output P1 even when the depth De of the defect is less than the specified depth De1, it is possible to suppress the occurrence of problems such as being unable to re-melt the surface of the fabrication product 15 during defect repair.
(14) In some embodiments, in the method of (12) or (13) above, in the step of repairing (step S29, step S37), it would be good to repair the defect by irradiating the energy beam (light beam 71) without scanning when the maximum dimension dmax of the defect when viewed from above the fabrication product 15 is less than twice the beam width db of the energy beam (light beam 71). In the step of repairing (step S29, step S37), it would be good to repair the defect by irradiating the energy beam (light beam 71) while scanning when the maximum dimension dmax of the defect when viewed from above the fabrication product 15 is equal to or greater than twice the beam width db of the energy beam (light beam 71).

According to the method of (14) above, since the energy beam (light beam 71) can be irradiated under appropriate irradiation conditions according to the size of the defect, when repairing a relatively small defect, excessive heating of the fabrication product 15 may be suppressed, and when repairing a relatively large defect, the necessary heating for defect repair can be performed. As a result, the quality of the fabrication product 15 may be improved.
(15) In some embodiments, in any one of the methods of (1) to (14) above, it would be good to include a step (step S13) of measuring the surface shape of the layer 8a and detecting presence or absence of a defect in the layer 8a on the basis of the surface shape of the layer 8a after performing the step (step S11) of forming the layer 8a and before performing the forming step (step S21).

According to the method of (15) above, it is possible to understand the good or bad state of the layer 8a formed by laying the raw material powder 30.
(16) In some embodiments, in the method of (15) above, it would be good to include a step (step S11) of newly forming a layer 8a of the raw material powder 30 by supplying the raw material powder 30 when a defect in the layer 8a is detected in the step of detecting (step S13).

According to the method of (16) above, the soundness of the layer 8a formed by laying the raw material powder 30 may be improved.
(17) An additive manufacturing apparatus (three-dimensional additive manufacturing apparatus 1) according to at least one embodiment of the present disclosure comprises a powder bed formation part 5 having a base plate 2 on which a layer 8a of supplied raw material powder 30 is formed, an energy beam irradiation part (light beam irradiation device 20) capable of irradiating an energy beam (light beam 71) onto the layer 8a, a first detection device 40 configured to detect presence or absence of a defect in the fabrication product 15 during irradiation of the energy beam (light beam 71), and a second detection device 50 configured to measure a surface shape of the fabrication product 15 after irradiating the energy beam (light beam 71) and detect presence or absence of a defect in the fabrication product 15 on the basis of the surface shape of the fabrication product 15. The powder bed formation part 5 is configured to form a layer 8a of the raw material powder 30 by supplying the raw material powder 30 after the first detection device 40 detects presence or absence of a defect in the fabrication product 15, and the second detection device 50 detects presence or absence of a defect in the fabrication product 15.

According to the configuration of (17) above, since presence or absence of a defect in the fabrication product 15 is detected during irradiation of the energy beam (light beam 71) for fabrication, the inspection time can be greatly reduced. Also, since presence or absence of a defect in the fabrication product 15 may be detected on the basis of the surface shape of the fabrication product 15 by the second detection device 50, inspection can be performed in a relatively short time. Therefore, according to the configuration of (17) above, the inspection time of the fabrication product 15 may be reduced.

Also, according to the configuration of (17) above, since presence or absence of defects may be detected by the first detection device 40 and the second detection device 50 every time each layer 8a is fabricated, non-destructive testing after the fabrication of the fabrication product 15 is completed may be omitted, and the inspection time and the cost required for inspection of the fabrication product 15 may be reduced.
(18) According to at least one embodiment of the present disclosure comprises a step of detecting presence or absence of a defect in the fabrication product 15 by any one of the methods for monitoring a fabrication process of (1) to (16) above.

According to the method of (18) above, a fabrication product 15 of good quality can be obtained while reducing the inspection time and the cost required for inspection of the fabrication product 15.

### Reference Signs List

1,1A Three-dimensional additive manufacturing apparatus (additive manufacturing apparatus)
Base plate
2a Drive cylinder
4 Cylinder
5 Powder bed formation part
6 Beam splitter
8 Powder bed
8a Layer
9 Chamber
9a Window part
8a Layer
10 Powder layering part
15 Fabrication product
20 Light beam irradiation device
21 Light beam irradiation part
22 Light beam control part
30 Raw material powder
31 Storage part
40 First detection device
41 Light detection part
42 Emission monitor control part
50 Second detection device
51 Projection part
52 Imaging part
53 Concavity/convexity detection part
60 Flaw detection device
61 Laser irradiation device
62 Laser interferometer
63 Flaw detection control part
71 Light beam
80 Control part
90 Surface processing irradiation device
91 Laser light irradiation part
92 Laser light control part
95 Laser light

1. A method for monitoring a fabrication process comprising:
a step of forming a part of a fabrication product by irradiating an energy beam onto a layer of raw material powder to fuse and solidify the raw material powder of the layer;
a first detection step of detecting presence or absence of a defect in the fabrication product during performance of the forming step; and
a second detection step of measuring a surface shape of the fabrication product and detecting presence or absence of a defect in the fabrication product on the basis of the surface shape of the fabrication product after performing the forming step,
wherein in the first detection step, presence or absence of a defect in a formed layer below an uppermost formed layer of the fabrication product is detected, and presence or absence of a problem in the uppermost formed layer of the fabrication product is detected, on the basis of emission intensity of light emitted from the fabrication product when irradiating the energy beam in the forming step, and
wherein the first detection step and the second detection step are performed each time the forming step is performed.

2-4. (canceled)

5. The method for monitoring a fabrication process according to claim 1, wherein in the first detection step, from among a plurality of measurement values of the emission intensity obtained by measuring the emission intensity multiple times during the performance of one forming step, at least one measurement value taken in order from the largest emission intensity measurement value is taken as a representative value of the emission intensity during the performance of the one forming step, and presence or absence of the defect or the problem is detected on the basis of the representative value and a predetermined reference value.

6. The method for monitoring a fabrication process according to claim 5, wherein in the first detection step, it is determined that there is no defect and no problem when the representative value is less than a threshold value determined on the basis of the reference value, and it is determined that there is the defect or the problem when the representative value is equal to or greater than the threshold value.

7. The method for monitoring a fabrication process according to claim 6, wherein in the first detection step, when performing the forming step multiple times, it is determined that there is no defect and no problem in the fabrication product when a frequency of occurrence of the representative values equal to or greater than the threshold value is less than a specified frequency, and it is determined that there is the defect or the problem when the frequency of occurrence of the representative values equal to or greater than the threshold value is equal to or greater than the specified frequency.

8. The method for monitoring a fabrication process according to claim 1, wherein in the second detection step, the surface shape of the fabrication product is measured by capturing an image of a pattern projected onto the surface of the fabrication product.

9. The method for monitoring a fabrication process according to claim 1, comprising
a step of inspecting the fabrication product to obtain a state of the defect or the problem when the defect or the problem is detected in the first detection step or the second detection step.

10. The method for monitoring a fabrication process according to claim 1, comprising:
a step of processing a surface of the fabrication product by irradiating a beam when the defect or the problem is detected in the first detection step or the second detection step; and
a step of inspecting the fabrication product whose surface has been processed in the step of processing the surface of the fabrication product to obtain a state of the defect or the problem.

11. The method for monitoring a fabrication process according to claim 9, wherein in the step of obtaining, the state of the defect or the problem is obtained by a laser ultrasonic method.

12. The method for monitoring a fabrication process according to claim 11, comprising
a step of repairing the defect or the problem by irradiating the energy beam under irradiation conditions set on the basis of the state of the defect or the problem obtained in the step of obtaining.

13. The method for monitoring a fabrication process according to claim 12, wherein in the step of repairing:
when a depth of the defect or the problem obtained in the step of obtaining is less than a specified depth, the defect or the problem is repaired by irradiating the energy beam at a first output; and
when the depth of the defect or the problem obtained in the step of obtaining is equal to or greater than the specified depth, the defect or the problem is repaired by irradiating the energy beam at a second output which is greater than the first output and becomes larger as the depth of the defect or the problem becomes deeper.

14. The method for monitoring a fabrication process according to claim 12, wherein in the step of repairing:
when a maximum dimension of the defect or the problem when viewed from above the fabrication product is less than twice the beam width of the energy beam, the defect or the problem is repaired by irradiating the energy beam without scanning; and
when the maximum dimension of the defect or the problem when viewed from above the fabrication product is equal to or greater than twice the beam width of the energy beam, the defect or the problem is repaired by irradiating the energy beam while scanning.

15. The method for monitoring a fabrication process according to claim 1, comprising:
a step of forming the layer by supplying the raw material powder; and
a step of measuring the surface shape of the layer and detecting presence or absence of a defect in the layer on the basis of the surface shape of the layer after performing the step of forming the layer and before performing the forming step.

16. The method for monitoring a fabrication process according to claim 15, comprising
a step of newly forming a layer of the raw material powder by supplying the raw material powder when a defect in the layer is detected in the step of detecting.

17. An additive manufacturing apparatus comprising:
a powder bed formation part having a base plate on which a layer of supplied raw material powder is formed;
an energy beam irradiation part capable of irradiating an energy beam onto the layer;
a first detection device configured to detect a defect presence or absence of in a fabrication product during irradiation of the energy beam; and
a second detection device configured to measure a surface shape of the fabrication product after irradiating the energy beam and detect presence or absence of a defect in the fabrication product on the basis of the surface shape of the fabrication product,
wherein the first detection device is configured to detect presence or absence of a defect in a formed layer below an uppermost formed layer of the fabrication product, and detect presence or absence of a problem in the uppermost formed layer of the fabrication product during irradiation of the energy beam, and
wherein the powder bed formation part is configured to form a layer of the raw material powder by supplying the raw material powder after the first detection device detects presence or absence of a defect in the formed layer below the uppermost formed layer of the fabrication product and a problem in the uppermost formed layer of the fabrication product and the second detection device detects presence or absence of a defect in the fabrication product.

18. An additive manufacturing method comprising a step of detecting presence or absence of the defect or the problem by the method for monitoring a fabrication process according to claim 1.
